(19) United States
(12) Patent Application Publication
(10) Pub. No.: US 2026/0278241 A1
(43) Pub. Date: Sep. 17, 2026

(54) TEXT PROCESSING

(71) Applicant: MASHANG CONSUMER FINANCE CO., LTD., Chongqing (CN)

(72) Inventors: Yantong LYU, Chongqing (CN); Wanjie TAO, Chongqing (CN)

(73) Assignee: MASHANG CONSUMER FINANCE CO., LTD., Chongqing (CN)

(21) Appl. No.: 19/333,302

(22) Filed: Sep. 18, 2025

(30) Foreign Application Priority Data
Mar. 12, 2025 (CN) 202510293230.X

(51) Int. Cl. G06F 40/117; G06F 16/334

(52) U.S. Cl. CPC G06F 40/117; G06F 16/334

(57) ABSTRACT

A text processing method includes: performing part-of-speech tagging on a sentence in a reference text for a first text to obtain respective categories of one or more words in the sentence, wherein the first text is generated based on a requirement text; generating a second text for describing the sentence based on the words and the respective categories of the words in the sentence; and determining a quality score of the first text based on a degree of matching between the second text and the first text.

### CROSS-REFERENCE TO RELATED APPLICATION

The present application claims priority to and the benefit of Chinese Patent Application No. 202510293230.X, filed on Mar. 12, 2025, the disclosure of which is incorporated herein by reference in its entirety.

### TECHNICAL FIELD

The present application relates to natural language processing technologies, and in particular, to text processing.

### BACKGROUND

Text evaluation is an important task in the field of natural language processing (NLP), which requires the system not only to automatically generate accurate and information-rich texts but also to comprehensively and accurately evaluate the quality of these texts. From early manual evaluation to later automated evaluation, such as those based on semantic similarity calculations and the application of machine translation evaluation metrics like the Bilingual Evaluation Understudy (BLEU) and the Recall-Oriented Understudy for Gisting Evaluation (ROUGE), the efficiency of the text evaluation has been significantly improved. However, how to further improve the comprehensiveness and accuracy of the text evaluation remains a key issue in the field of natural language processing.

### SUMMARY

In a first aspect, some embodiments of the present application provide a text processing method, including: performing part-of-speech tagging on a sentence in a reference text for a first text to obtain respective categories of one or more words in the sentence, wherein the first text is generated based on a requirement text; generating at least one second text for describing the sentence based on the words and the respective categories of the words; and determining a quality score of the first text based on a degree of matching between the second text and the first text.

In a second aspect, some embodiments of the present application provide a text processing apparatus, including: a tagging module, configured to perform part-of-speech tagging on a sentence in a reference text for a first text to obtain respective categories of one or more words in the sentence, where the first text is generated based on a requirement text; a generation module, configured to generate at least one second text for describing the sentence based on the words and the respective categories of the words; and a determination module, configured to determine a quality score of the first text based on a degree of matching between the second text and the first text.

In a third aspect, some embodiments of the present application provide an electronic device, including: a processor; and a storage storing instructions executable by the processor to perform the text processing method provided in the first aspect.

In a fourth aspect, some embodiments of the present application provide a computer-readable storage medium storing instructions executable by a processor of an electronic device to perform the text processing method provided in the first aspect.

In a fifth aspect, some embodiments of the present application provide a computer program product including a computer program executable by a computer to perform the text processing method provided in the first aspect.

### BRIEF DESCRIPTION OF THE DRAWINGS

FIG. 1 is a schematic diagram of an environment where a text processing method according to some embodiments of the present application can be implemented.

FIG. 2 is a schematic flowchart of an example of a text processing method according to some embodiments of the present application.

FIG. 3 is a schematic flowchart of another example of a text processing method according to some embodiments of the present application.

FIG. 4 is a schematic block diagram of a text processing apparatus according to some embodiments of the present application.

FIG. 5 is a schematic block diagram of an electronic device according to some embodiments of the present application.

FIG. 6 is a schematic flowchart of a step of a text processing method according to some embodiments of the present application.

FIG. 7 is a schematic flowchart of a step of a text processing method according to some embodiments of the present application.

### DETAILED DESCRIPTION

Some embodiments of the present application will be described in detail below with reference to the accompanying drawings. The embodiments are described for illustrative purposes only and are not intended to limit the present application.

The terms “first”, “second”, etc. in the specification, claims, and the above drawings of the present application are used to distinguish similar objects, and are not necessarily used to describe a specific order or sequential order. It should be understood that the terms used in this way may be interchangeable under appropriate circumstances, and this is merely a way of distinguishing the objects of the same attributes when describing them in the embodiments of the present application. In addition, the terms “including/comprising” and “having” and any of their variations are intended to cover non-exclusive inclusions, so that the process, method, system, product, or device comprising a series of units need not be limited to those units, but may include other units that are not clearly listed or inherent to the process, method, product, or device.

### Explanation of Some Terms

Conditional Random Field (CRF) is a Markov random field of random variable Y under the condition of a given random variable X, and is often used for tasks such as labeling and entity recognition.

Natural Language Toolkit (NLTK) is a Python library for processing and analyzing natural language text. It can facilitate natural language processing tasks, including word segmentation, part-of-speech tagging, named entity recognition, and syntactic parsing.

Text evaluation methods in related art are mainly divided into two categories: manual evaluation and automatic evaluation. The manual evaluation involves manual scoring or comparing texts to evaluate the quality of the texts. Thus the manual evaluation is highly intuitive, but is time-consuming and difficult to scale, and the evaluation results thereof may lack consistency due to subjectivity bias. The automatic evaluation mainly relies on semantic similarity or machine translation evaluation metrics such as BLEU and ROUGE to evaluate the quality of the texts. However, the automatic evaluation based on the machine translation evaluation metrics relies too much on the literal similarity between a text to be evaluated and a reference text, and cannot accurately measure semantic equivalence, resulting in inaccurate evaluation. Although the automatic evaluation based on the semantic similarity has achieved certain improvements at the semantic level, their performance in specific fields and tasks is still limited. For example, in the specific fields, the key information of the text to be evaluated and the reference text may exist in the form of terms, symbols or, implicit semantics. The lack or ambiguity of the semantic information will lead to inaccurate evaluation.

In view of this, an embodiment of the present application provides a text processing method. Since the word and the category of the word in a sentence may objectively and accurately reflect the sentence component of the sentence, the word and the category of the word in the sentence contain key information of the sentence, and play a key role in the expression of semantics of the sentence. Therefore, the traditional method that relies on surface-level vocabulary matching is abandoned. In an embodiment of the present application, a first text is generated based on the requirement text, and the second text for describing the sentences of the reference text is generated based on the word and the category of the word in the sentence of the reference text for the first text. This is equivalent to decomposing the semantic structure of the sentence, and helps to improve the depth of understanding for the content of the sentence. Then, based on the semantic understanding for the second text, the quality of the first text is evaluated. This evaluation method may go deep into the sentence and accurately evaluate whether the first text contains the key information of each sentence in the reference text. Not only is the evaluation more accurate and comprehensive, but it is also more robust to the language expression form. Even if the first text expresses the same meaning as the reference text in a different language from the reference text, their equivalence may still be recognized.

It should be understood that the text processing method according to an embodiment of the present application may be executed by an electronic device. As an example, it may be executed by software in the electronic device. The electronic devices referred to herein may include terminal devices, such as smartphones, tablet computers, laptop computers, desktop computers, intelligent voice interaction devices, smart home appliances, smart watches, vehicle-mounted terminals, aircraft, etc. Or the electronic device may include a server such as an independent physical server, a server cluster or a distributed system formed by a plurality of physical servers, or a cloud server providing cloud computing services.

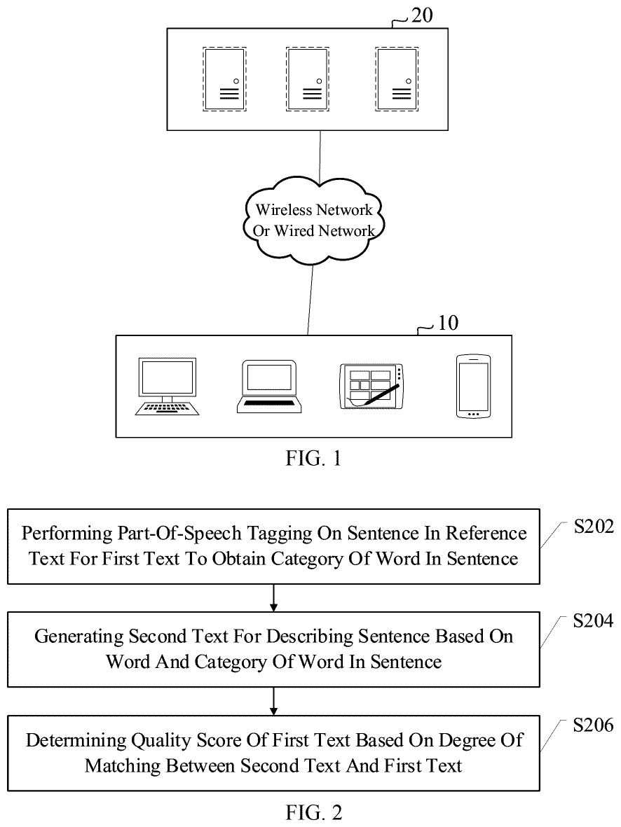

Before providing a detailed description of the text processing method according to an embodiment of the present application, a brief description to the implementation environment involved in the embodiments of the present application will be provided. FIG. 1 is a schematic diagram of an environment where a text processing method according to some embodiments of the present application can be implemented. The implementation environment includes a terminal 10 or the implementation environment includes the terminal 10 and a text processing platform 20. The terminal 10 is connected to the text processing platform 20 via a wireless network or a wired network.

The terminal 10 may be a terminal device, such as at least one of a smartphone, a tablet computer, a laptop computer, a desktop computer, an intelligent voice interaction device, a smart home appliance, a smart watch, a vehicle-mounted terminal, an aircraft, and the like. The terminal 10 may have been installed with and run an application program that supports text processing. For example, the application program may be a system application or a word processing application.

For example, the terminal 10 may evaluate the quality of the text to be processed based on a reference text. In response to that the quality of the text to be processed does not meet the requirements, the text to be processed is revised and then re-evaluated until the revised text meets the requirements. The terminal 10 may complete this task independently or through data services provided by the text processing platform 20. This embodiment of the present application is not limited to this.

The text processing platform 20 includes at least one of a single server, multiple servers, a cloud computing platform, and a virtualization center. The text processing platform 20 provides backend services for the application program that supports text processing. Or, the text processing platform 20 performs primary processing, while the terminal 10 performs secondary processing. Alternatively, the text processing platform 20 performs secondary processing, while the terminal 10 performs primary processing. Alternatively, either the text processing platform 20 or the terminal 10 may operate independently.

In an example, the terminal 10 receives the text to be processed and the reference text input by a user, and sends these texts to the text processing platform 20. The text processing platform 20 then evaluates the quality of the text to be processed based on the reference text. In response to that the quality of the text to be processed does not meet the quality requirements, the text to be processed is revised and re-evaluated until the revised text meets the quality requirements. The text processing platform 20 then sends an evaluation result for the text to be processed to the terminal 10, which then displays the evaluation result to the user.

Based on the implementation environment described above, the text processing method according to an embodiment of the present application is described in detail with reference to the accompanying drawings.

FIG. 2 is a flowchart of an example of a text processing method according to some embodiments of the present application. The method includes Steps S202 to S206.

At Step S202, part-of-speech tagging is performed on a sentence in a reference text for a first text to obtain respective categories of one or more words in the sentence.

The first text is generated based on a requirement text. The requirement text may be any text to be processed. Depending on the application scenario, the first text may be generated in various ways. The first text has the reference text corresponding to this first text. The reference text is used to evaluate the quality of the first text. For example, in a text summarization scenario, if a certain text is to be summarized, the text to be summarized is the requirement text, the first text may be a summary generated by summarizing the requirement text, and the reference text may be a reference summary annotated for the requirement text and used to evaluate the quality of the generated summary. In a model hallucination detection scenario, if hallucination detection is to be performed on text generated by an Large Language Model (LLM), a prompt word instructing the LLM to perform a certain text generation task (such as script writing, intelligent question and answer) is the requirement text, the first text may be a text generated by performing the text generation task by the LLM, and the reference text may be a reference text annotated for the text generation task.

In an embodiment, sentence segmentation processing is performed on the reference text to obtain a plurality of sentences. Then, the part-of-speech tagging is performed on each of the sentences to obtain the categories of the words in the sentence. The category of the word refers to a grammatical role that the word plays in the sentence or functional characteristics of the word in the sentence. The category of the word may include, but is not limited to, a noun, a verb, an adjective, a numeral, a quantifier, and the like.

Performing sentence segmentation processing on the reference text may be implemented in various appropriate ways, which are not limited to the presented embodiments of the present application. In an implementation, the reference text is segmented into the plurality of sentences by using NLTK.

In another implementation, punctuation marks play an important role in dividing semantic units in the text. For example, a period “.”, a question mark “?”, and an exclamation mark “!” typically mark the end of the sentence, and a semicolon “;” may separate sentences that are semantically relatively independent yet related. Therefore, the reference text may be segmented into the plurality of sentences by recognizing these punctuation marks. For example, for the reference text “The weather is very nice today. Shall we go hiking? We can enjoy the scenery along the way.”, the reference text may be segmented into three sentences according to the question mark and the period: “The weather is very nice today.”, “Shall we go hiking?”, and “We can enjoy the scenery along the way.”.

Part-of-speech tagging of the sentence may be implemented in various appropriate ways, which are not limited to the presented embodiments of the present application. For example, the category of each word in the sentence may be recognized through the named entity recognition model (such as a CRF model), or the category of each word in the sentence may be recognized based on pre-defined rules, deep learning, or other methods.

At Step S204, a second text for describing the sentence is generated based on the words and the categories of the words in the sentence.

The second text may have various appropriate forms. As an example, the second text may include key information in the sentence of the reference text. As another example, the second text may include a first question text and a first answer text corresponding to the first question text. Since the words and their categories in the sentence may objectively and accurately reflect the sentence components, contain the key information of the sentence, and play a key role in the expression of semantics. Therefore, the question-answer pair composed of the first question text and the first answer text may not only accurately describe the semantics of the sentence in the reference text, but also highlight the key information of the sentence of the reference text.

In an implementation, sine a verb is generally used as a predicate of a sentence and are a core part of semantic expression of the sentence, the second text is generated by using the verb of the sentence of the reference text and a preset interrogative word, thereby accurately describing the semantics of the sentence and include core information of the sentence, providing strong data support for subsequent accurate and comprehensive evaluation of the quality of the first text. In an embodiment, as shown in FIG. 6, the Step S204 includes Step S241 to Step S243.

At Step S241, a first question text is generated based on a preset interrogative word and a first word of the words in the sentence whose category is a verb.

As an example, the first question text may be generated according to the following template:
[WH AUX SBJ TRG OBJ1 PP OBJ2],
   where WH represents an interrogative word, including but not limited to “what”, “who”, “where”, “when”, “why”, “how”, etc., and WH is used to construct a backbone of the first question text; AUX represents an auxiliary verb, including but not limited to “is”, “was”, “does”, etc., and AUX is used to provide grammatical assistance; SBJ represents an subject, and SBJ is used to clarify the subject information of the sentence; TRG represents an verb, and TRG may reflect a predicate of a sentence and is the key to the generation of the first question text; OBJ1 represents a first object, and OBJ1 is used to supplement semantic information of a direct object receiving the action done by the subject in the sentence; PP represents a prepositional phrase, including but not limited to “by”, “to”, “for”, “with”, “about”, etc.; and OBJ2 represents a second object, which is used to supplement semantic information of an indirect object receiving the action done by the subject in the sentence.

In actual applications, after the first word as a verb is determined, the Wiktionary dictionary is used to map the first word to its simple or root form (base form), ensuring that the verb appears in its standard root form. For example, the first word in a derived form or a tense-inflected form is mapped into the base verb form thereof.

In addition, the Step S241 may be implemented through LLM. For example, by inputting the sentence of the reference text and a corresponding prompt word into the LLM, the first question text may be obtained. The prompt word is used to indicate that the first question text is generated according to the above template. The prompt word may set a requirement for generating the first question text, including but not limited to: (1) content orientation: each generated first question text must help understand the core content of the original sentence and is generated by focusing on the verb and the core semantics of the original sentence; (2) generation constraint: the fields of the first question text must be included in the above template, fields “WH” and “TRG” are required, and the remaining fields are optional, and the grammar of the first question text must comply with the language expression norms.

For example, for a sentence “Dr. Smith discussed AI application in healthcare.”, the first word is “discussed”. The first word is mapped to the basic verb form thereof “discuss”. Then, by using the interrogative words “What” and “Who”, the following two first question texts Q1 and Q2 are generated:
Q1: What did Dr. Smith discuss?
Q2: Who discussed AI applications in healthcare?

At Step S242, a first answer text corresponding to the first question text is obtained from the sentence.

As an example, based on the type of the interrogative word, the sentence component type corresponding to the interrogative word is determined; and based on the categories of the words in the sentence of the reference text, a first sentence component belonging to the sentence component type is extracted from the sentence as the first answer text corresponding to the first question text.

For example, for the first question text Q1, the sentence component type corresponding to the interrogative word “What” is the object. In a sentence, the object serves as the direct object receiving a verbal action or behavior, and generally includes nouns, pronouns, numerals, verbs of non-predicate forms, nominalized adjectives, object clauses, etc. Based on this, the first sentence component “AI applications in healthcare”, which belongs to the object, is extracted from the sentence based on the categories of the words in the sentence of the reference text as the first answer text corresponding to the first question text Q1.

For the first question text Q2, the sentence component type corresponding to the interrogative word “Who” is the subject. The subject, as the primary actor for performing the action or bearer of state in the sentence, is generally located at the beginning of the sentence and generally includes nouns, pronouns, numerals, noun phrases, verbs of non-predicate forms, clauses, etc., Based on this, the first sentence component “Dr. Smith”, which belongs to the subject, is extracted from the sentence based on the categories of the words in the sentence of the reference text as the first answer text corresponding to the first question text Q2.

The first answer text generated in the above method is not only accurate but also may highlight the core information of the sentence.

As another example, the first question text, the prompt word for generating an answer text, and the sentence of the reference text may be input into the LLM. By using semantic understanding capability and text generation capability of the LLM, the first answer text may be generated. The prompt word indicates the extraction of an answer text for the first question text from the sentence. A requirement for generating an answer text may be set in the prompt word, the requirement for generating the answer text includes but is not limited to an answer text constraint, e.g., no more than three answer texts per question text, the answer text revolving accurately around the semantics of the question text and being brevity and informative.

At Step S243, the second text for describing the sentence is generated based on the first question text and the first answer text.

As an example, a question-answer pair obtained by combining the first question text with the first answer text may be determined as the second text.

As another example, the first question text and the first answer text are combined to obtain a first question-answer pair; reconstructing a first sentence based on the first question-answer pair; and in response to verifying that the first sentence is semantically consistent with the sentence, the first question-answer pair is determined as the second text.

In an embodiment, a preset template is populated with the first question-answer pair to obtain the first sentence. This preset template uses a different linguistic representation from the original sentence. For example, if the original sentence is in active voice, the preset template may use passive voice. Alternatively, the first question-answer pair, a prompt word for the sentence reconstruction, and the first answer text may be input into the LLM. By using the semantic understanding capability and the text generation capability of the LLM, the first sentence with the same semantics as the first question-answer pair may be generated.

Then, the sentence of the reference text, the first sentence, and the prompt words for the semantic consistency verification are input into the LLM. By using semantic understanding capability of the LLM, it is determined whether the semantics of the sentence are consistent with the semantics of the first sentence. In response to that they are semantically consistent, the first question-answer pair is determined to be accurate and contains the core information of the sentence, and the first question-answer pair is then determined as the second text.

For example, for the first question text Q1 and its corresponding first answer text “AI applications in healthcare”, the first question-answer pair Q&A1 may be obtained:
Q&A1:
Q1: What did Dr. Smith discuss?
A1: AI applications in healthcare.

The sentence reconstruction is performed on the first question-answer pair to obtain the first sentence “AI applications in healthcare were discussed by Dr. Smith.”. Since the semantics of the sentence of the reference text is consistent with the semantics of the first sentence, Q&A1 is determined as the second text.

For the first question text Q2 and its corresponding first answer text “Dr. Smith”, the first question-answer pair Q&A2 may be obtained:
Q&A2:
Q2: Who discussed AI applications in healthcare?
A2: Dr. Smith.

The sentence reconstruction is performed on the first question-answer pair to obtain the first sentence “Dr. Smith. discussed AI applications in healthcare.” Since the semantics of the sentence of the reference text is consistent with the semantics of the first sentence, Q&A2 is determined as the second text.

In the above implementation, the first question-answer pair serves to deconstruct the semantic structure of the sentence, which helps to understand the content of the sentence and extract the key information of the sentence. The first sentence reconstructed based on the first question-answer pair may more accurately and smoothly describe the content of the first question-answer pair. Further, by verifying the semantic consistency between the first sentence and the original sentence of the reference text, it is possible to accurately determine whether the first question-answer pair retains the semantic core of the original sentence, thereby obtaining the second text that retains the semantic core of the original sentence, providing reliable data support for the subsequent accurate and comprehensive evaluation of the quality of the first text.

As another example, in response to verifying that the first sentence is semantically inconsistent with the sentence, information on semantic difference between the sentence and the first sentence is obtained; and the first question-answer pair is modified based on the information on the semantic difference to obtain the second text.

For example, in response to that the semantics of the sentence are inconsistent with those of the first sentence, it is determined that the first question-answer pair does not contain the core information of the sentence. Then, the sentence, the first sentence, and the prompt word for obtaining the semantics difference are input into the LLM. By using the semantic understanding capability and the text generation capability of the LLM, factors that cause the semantics difference between the sentence and the first sentence are recognized, such as factors that cause the semantics deviation by improper syntactic structure, inaccurate verb mapping, or improper use of prepositions. The first question-answer pair is modified based on these factors until the first sentence reconstructed based on the modified first question-answer pair is semantically consistent with the sentence. At this time, the modified first question-answer pair is determined as the second text.

For the above Step S204, in another implementation, based on the categories of the words in the sentence, the sentence components contained in the sentence are determined, including but not limited to the subject, predicate, object, adverbial, etc. Then, according to the preset interrogative word and the predicate of the sentence, the first question text is generated; the sentence component corresponding to the interrogative word is obtained from the sentence as the first answer text; and based on the first question text and the first answer text, the second text is generated.

Some implementations of the above Step S204 are described above. It should be understood that the above Step S204 may be implemented in other ways, which are not limited to the presented embodiments of the present application.

It is noted that in actual applications, the number of first question texts may be more than one but should not exceed a preset first quantity threshold, such as five, to avoid excessive complexity. The number of the answer texts corresponding to each first question text may be more than one but should not exceed a preset second quantity threshold to ensure brevity and information density thereof.

At Step S206, a quality score of the first text is determined based on degree of matching between the second text and the first text.

The degree of matching between the second text and the first text may be implemented in various appropriate ways, which are not limited to the presented embodiments of the present application. In an implementation, under the condition that the second text includes a first question text and a first answer text corresponding to the first question text, a second answer text corresponding to the first question text is extracted from the first text by using a first model based on the first question text; and the degree of matching between the second text and the first text is determined based on the similarity between the second answer text and the first answer text.

The first model may be any model with semantic understanding and text processing capabilities, such as the LLM, etc., which is not limited to the presented embodiments of the present application.

For example, the first text is “The new product is a smartwatch. It has an advanced health-monitoring, a long-lasting battery and a high-resolution display. It will be available next month.”, and the reference text is “The new product is a smartwatch with advanced health-monitoring, long-lasting battery, high-resolution display and will be available next month.”.

Based on the sentence in the reference text, the following three second texts are obtained:

```
QA_{11}:
  Q: What is the new product?
  A: It is a smartwatch with advanced health-monitoring features.
QA_{12}:
  Q: What are the unique selling points of the smartwatch?
  A: It has a long-lasting battery and a high-resolution display.
QA_{13}:
  Q: When will the product be available?
  A: It will be available next month.
```

For the above second text QA_{11}, the second answer text “a smartwatch with advanced health-monitoring” is extracted from the first text by using the first model. In response to that the similarity between the second answer text and the first answer text is greater than a preset similarity threshold, it is determined that the first answer text may be extracted from the first text, and then it is determined that the second text matches the first text. Therefore, the similarity may be determined as the degree of matching between the second text and the first text.

For the above second text QA_{12}, the second answer text “advanced health-monitoring, long-lasting battery, high-resolution display” is extracted from the first text by using the first model. In response to that the similarity between the second answer text and the first answer text is greater than the similarity threshold, it is determined that the first answer text may be extracted from the first text, and then it is determined that the second text matches the first text. Therefore, the similarity may be determined as the degree of matching between the second text and the first text.

For the above second text QA_{13}, the second answer text “be available next month” is extracted from the first text by using the first model. In response to that the similarity between the second answer text and the first answer text is greater than the similarity threshold, it is determined that the first answer text may be extracted from the first text, and then it is determined that the second text matches the first text. Therefore, the similarity may be determined as the degree of matching between the second text and the first text.

In the above implementation, the degree of matching between the second text and the first text is determined based on the similarity between the second answer text extracted from the first text and the first answer text, so that the quality assessment for the first text focuses more on whether the first text conveys the key information of the reference text, making it more robust to the language expression form. Even if the first text uses a different language expression form from the reference text to express the same meaning as the reference text, their equivalence may still be recognized.

In another implementation, sentence reconstruction is performed on the second text to obtain a second sentence; then, by using the first model, it is determined whether the second sentence may be extracted from the first text; in response to that the second sentence is extracted from the first text, it is determined that the second text matches the first text; and in response to that the second sentence is not extracted from the first text, it is determined that the second text does not match the first text.

After obtaining the degree of matching between the second text and the first text, the quality of the first text may be evaluated in various appropriate ways to obtain a quality score of the first text.

In an implementation, since each sentence in the reference text has a corresponding second text, the more second texts that match the first text, the more accurately the second texts describe the semantics of the sentences of the reference text and highlight the key information of the sentences. Therefore, the more second texts that match the first text indicate that the first text more comprehensively and accurately contains the core information of the reference text. Based on this, the quality score of the first text may be determined based on the number of the second texts that match the first text.

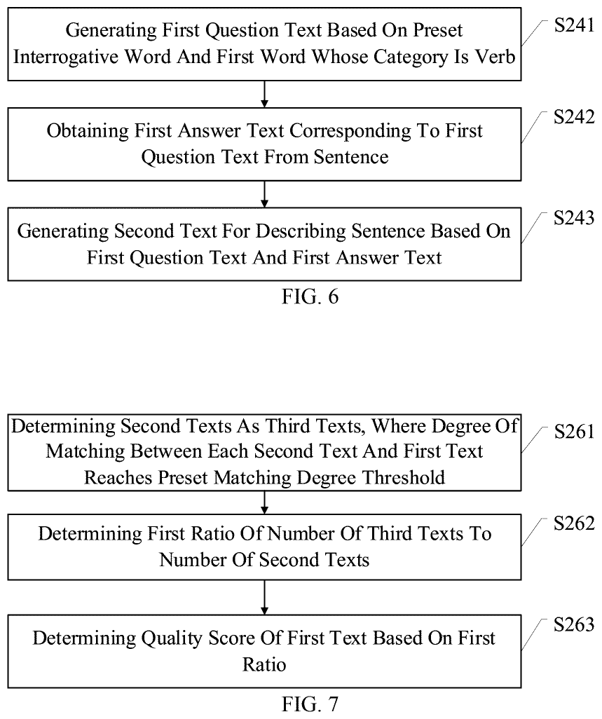

In an embodiment, as shown in FIG. 7, the above Step S206 includes Steps S261 to S263.

At Step S261, one or more of the second texts are determined as one or more third texts, where a degree of matching between each of the one or more of the second texts and the first text reaches a preset matching degree threshold.

For example, taking the three second texts QA_{11}, QA_{12}, and QA_{13} as an example, each of the three second texts matches the first text, so each of the three second texts is determined to be the third text.

At Step S262: a first ratio of the number of the third texts to the number of the second texts is determined.

At Step S263: a quality score of the first text is determined based on the first ratio.

As an example, the first ratio is determined as the quality score of the first text:

$${Score}_{i} = \frac{{\sum }_{j = 1}^{{K}_{i}} Presence ( {QA}_{ij} , {s}_{i} )}{{K}_{i}} ,$$

where Scoreᵢ represents the quality score of the first text; Presence (QAᵢⱼ, sᵢ) represents whether the second text QAᵢⱼ matches the first text sᵢ or not (if yes, Presence (QAᵢⱼ, sᵢ)=1; and if no,

$$Presence ( {QA}_{ij} , {s}_{i} ) = 0 ) ; {\sum }_{j = 1}^{{K}_{i}} Presence ( {QA}_{ij} , {s}_{i} )$$

represents the number of the third texts; and Kᵢ represents the number of the second texts.

As another example, under the condition that the first text has a relatively longer length, the number of second texts matching the first text may be greater, thereby unfairly increasing the quality score of the first text. To this end, an embodiment of the present application is intended to avoid obtaining a greater quality score by merely increasing the length of the first text, thereby ensuring the fairness in the quality assessment. The Step S263 described above may include: determining a first coefficient based on the relationship between the length of the first text and the length of the reference text; and determining the quality score of the first text based on the first coefficient and the first ratio. The length of the text refers to the number of characters included in the text.

In an example, under the condition that the length of the first text does not exceed that of the reference text, the first coefficient is set to one. Under the condition that the length of the first text exceeds that of the reference text, the greater the difference between the length of the first text and the length of the reference text, the less the first coefficient, so that the first coefficient may serve as a penalty for the quality of the first text, thereby avoiding obtaining a greater quality score by merely increasing the length of the first text, and thereby ensuring the fairness in the quality assessment.

For example, the first coefficient may be determined by: determining a second ratio of the length of the first text to the length of the reference text; and performing a first exponential operation on the second ratio to obtain the first coefficient. The first coefficient is negatively correlated with the second ratio.

For example, the first coefficient may be determined by the following formula:

$${p}_{l} = {e}^{min ( 0 , 1 \frac{\vert {s}_{i} \vert}{\vert {r}_{i} \vert} )} ,$$

where pᵢ represents the first coefficient, |sᵢ| represents the length of the first text sᵢ, and |rᵢ| represents the length of the reference text rᵢ.

After obtaining the first coefficient, the product of the first coefficient and the first ratio may be determined as the quality score of the first text, that is, the quality score of the first text is FinalScorei=Scoreᵢ×pᵢ.

Thus, under the condition that the length of the first text does not exceed the length of the reference text, that is, |sᵢ|≤|rᵢ|, then pᵢ=1. Under the condition that the length of the first text exceeds the length of the reference text, that is, |sᵢ|>|rᵢ|, the first coefficient decreases exponentially, and thus the quality score of the first text also decreases exponentially, thereby effectively avoiding obtaining a greater quality score by merely increasing the length of the first text, and thereby ensuring the fairness in the quality assessment.

Alternatively, the product of the first coefficient and the first ratio may be determined, and the quality score of the first text may be determined based on a preset mapping between the product and the quality score. The preset mapping may be obtained based on expert experience or big data analysis, and is not limited to the presented embodiment of the present application.

Regarding the above Step S206, in another implementation, the second text matching the first text may be determined as the third text; and the quality score of the first text may be determined based on a preset mapping between the number of the third text and the quality score.

Some implementations of the above Step S206 are described above. It should be understood that the above Step S206 may be implemented in other ways, which are not limited to the presented embodiments of the present application.

In the text processing method according to one or more embodiments of the present application, because the words and the categories of the words in the sentence may objectively and accurately reflect the sentence component, the word and the category of the word in the sentence contain the key information of the sentence and play a key role in the expression of semantics of the sentence. For the first text generated based on the requirement text, a second text for describing the sentence is first generated based on the words and the categories of the words in the sentence of the reference text for the first text, which is equivalent to decomposing the semantic structure of the sentence, and helps to improve the depth of understanding for the core information (such as actions, objects and associations, etc.) of the sentence. Therefore, the second text may not only accurately describe the semantics of the sentence of the reference text, but also highlight the key information of the sentence. Therefore, the degree of matching between the second text and the first text may accurately reflect whether the first text contains the key information of each sentence in the reference text. Then, based on the degree of matching between the second text and the first text, the quality score of the first text is determined. Thus, the quality of the first text may be comprehensively and accurately evaluated. Moreover, since this evaluation method focuses more on whether the first text conveys the key information of the reference text, it has stronger robustness to the language expression form. Even if the first text expresses the same meaning as the reference text in a different language from the reference text, their equivalence may still be recognized. Moreover, even if there are some errors in the details of the first text, as long as the first text contains the core information of the reference text, its value will not be completely denied, which is more in line with human evaluation habits.

The text processing method according to an embodiment of the present application may be applied to various business scenarios. Text summarization and model hallucination detection scenarios are described as examples for illustration. It should be understood that the application of the text processing method to the text summarization and the model hallucination detection scenarios is merely exemplary. It should be understood that application scenario of the method is not limited hereto.

In the text summarization scenario, a summary obtained by summarizing a certain text is taken as the first text, and a reference summary annotated for the certain text is taken as the reference text for the first text.

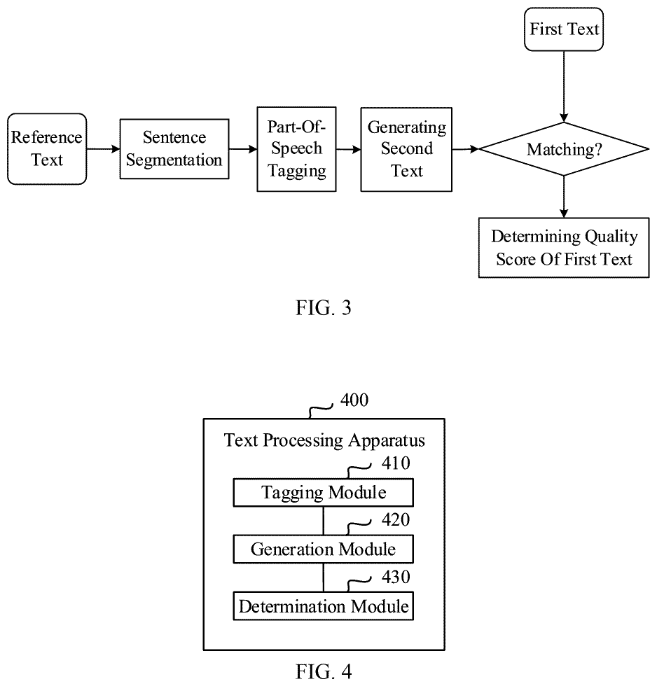

As shown in FIG. 3, first, the reference text is segmented to obtain a plurality of sentences; then, for each of the sentences, part-of-speech tagging is performed on each of the sentences to obtain categories of words in the sentence; a second text for describing the sentence is generated based on the words and the categories of the words in the sentence; degree of matching between each second text and the first text is determined; and a quality score of the first text is determined based on degree of matching.

Under the condition that the quality score of the first text does not meet the requirement, for example, under the condition that the quality score of the first text is less than a preset score threshold, the first text is modified based on the second text that does not match the first text, to obtain a modified first text. Alternatively, the requirement text is summarized by using another summarization method to obtain another first text. Alternatively, the requirement text and other prompt word are input into the LLM, and the LLM re-summarizes the requirement text according to the other prompt word to obtain another first text. The quality of the other first text is then evaluated by using the above evaluation method. This process is repeated until the quality score of the first text meets the requirement.

In text generation tasks like scriptwriting, intelligent question answering, and the like by using the LLM, LLM often produces hallucinations, that is, the text generated by the LLM includes false information or fabricated content that don't match the facts. The LLM-generated text may appear grammatically correct and logically coherent, but is actually inaccurate or completely fabricated. In such cases, the LLM-generated text may be used as the first text, and the reference result of the text generation task may be used as the reference text.

As shown in FIG. 3, first, the reference text is segmented to obtain a plurality of sentences; then, for each of the sentences, part-of-speech tagging is performed on each of the sentences to obtain categories of words in the sentence; a second text for describing the sentence is generated based on the words and the categories of the words in the sentence; degree of matching between each second text and the first text is determined; and a quality score of the first text is determined based on degree of matching.

Under the condition that the quality score of the first text does not meet the requirement, for example, under the condition that the quality score of the first text is less than a preset score threshold, the first text is modified based on the second text that does not match the first text, to obtain a modified first text. Alternatively, the prompt word input to the LLM is modified, and the LLM then regenerates the text based on the modified prompt word to obtain another first text. The quality of the other first text is then evaluated by using the above evaluation method. This process is repeated until the quality score of the first text meets the requirement. Therefore, false information or fabricated content in the LLM-generated text that does not match the facts may be corrected, the illusion problem of the LLM may be addressed.

Some embodiments of the present application have been described above. Other embodiments fall within the scope of the appended claims. In some cases, the operations or steps recited in the claims may be performed in an order different from that that described in the embodiments and still achieve the desired results. Furthermore, the processes depicted in the accompanying drawings do not necessarily require the specific or the sequential order shown to achieve the desired results. In certain implementations, multitasking and parallel processing are also possible or may be advantageous.

Similarly, some embodiments of the present application also provide a text processing apparatus. FIG. 4 shows a schematic diagram of a text processing apparatus 400 according to some embodiments of the present application. The text processing apparatus 400 includes a tagging module 410, a generation module 420, and a determination module 430.

The tagging module 410 is configured to perform part-of-speech tagging on a sentence in a reference text for a first text to obtain respective categories of one or more words in the sentence, wherein the first text is generated based on a requirement text.

The generation module 420 is configured to generate at least one second text for describing the sentence based on the words and the respective categories of the words.

The determination module 430 is configured to determine a quality score of the first text based on a degree of matching between the second text and the first text.

In another embodiment, the generation module is configured to:
generate a first question text based on a preset interrogative word and a first word of the words whose category is a verb;
obtain a first answer text corresponding to the first question text from the sentence; and
generate the second text based on the first question text and the first answer text.

In another embodiment, in the step of obtaining the first answer text corresponding to the first question text from the sentence by the generation module, the generation module performs the following operations:
determining a sentence component type corresponding to a preset interrogative word based on a type of the preset interrogative word; and
extracting a first sentence component belonging to the sentence component type from the sentence based on the respective categories of the words, as the first answer text.

In another embodiment, in the step of generating the second text for describing the sentence based on the first question text and the first answer text by the generation module, the generation module performs the following operations:
combining the first question text with the first answer text to obtain a first question-answer pair;
reconstructing a first sentence based on the first question-answer pair; and
in response to verifying that the first sentence is semantically consistent with the sentence, determining the first question-answer pair as the second text.

In another embodiment, the generation module is further configured to:
in response to verifying that the first sentence is semantically inconsistent with the sentence, obtaining information on semantic difference between the sentence and the first sentence, and modifying the first question-answer pair based on the information on the semantic difference to obtain the second text.

In another embodiment, the determination module is configured to:
determining one or more of the second texts as one or more third texts, wherein a degree of matching between each of the one or more of the second texts and the first text reaches a preset matching degree threshold;
determining a first ratio of a number of the third texts to a number of the second texts; and
determining the quality score of the first text based on the first ratio.

In another embodiment, in the step of determining the quality score of the first text based on the first ratio, the determination module performs the following operations:
determining a first coefficient based on a relationship between a length of the first text and a length of the reference text; and
determining the quality score of the first text based on the first coefficient and the first ratio.

In another embodiment, in the step of determining the first coefficient based on the relationship between the length of the first text and the length of the reference text, the determination module performs the following operations:
determining a second ratio of the length of the first text to the length of the reference text; and
performing a first exponential operation on the second ratio to obtain the first coefficient, wherein the first coefficient is negatively correlated with the second ratio.

In another embodiment, the second text comprises a first question text and a first answer text corresponding to the first question text;

In the step of determining the degree of matching between the second text and the first text, the determination module performs the following operations:
extracting a second answer text corresponding to the first question text from the first text by using a first model; and
determining the degree of matching between the second text and the first text based on similarity between the second answer text and the first answer text.

The text processing apparatus according to an embodiment of the present application may serve as an execution subject of the text processing method shown in FIG. 2. For example, in the text processing method shown in FIG. 2, Step S202 may be executed by the tagging module 410 in the text processing apparatus shown in FIG. 4, Step S204 may be executed by the generation module 420 in the text processing apparatus shown in FIG. 4, and Step S206 may be executed by the determination module 430 in the text processing apparatus shown in FIG. 4.

According to another embodiment of the present application, the various modules in the text processing apparatus shown in FIG. 4 may be individually or completely combined into one or several other modules for forming another text processing apparatus, or one (or some) of the modules may be further divided into a plurality of functionally smaller modules for forming another text processing apparatus, as long as the other text processing apparatus may achieve the same operation as the original text processing apparatus without affecting the realization of the technical effects in the embodiment of the present application. The above-mentioned units are divided based on logical functions. In actual applications, the functions of one module may be implemented by a plurality of modules, or the functions of a plurality of modules may be implemented by one module. In an embodiment of the present application, the text processing apparatus may further include other modules. In actual applications, these modules may be implemented with the assistance of the other modules, and may be implemented by the collaboration of a plurality of modules.

According to another embodiment of the present application, a text processing apparatus as shown in FIG. 4 may be configured, and the text processing method according to an embodiment of the present application may be implemented, by running a computer program (including program code) configured to execute each step in the corresponding text processing method shown in FIG. 2 on a general-purpose computing device, such as a computer, including a processing element such as a central processing unit (CPU) and storage elements such as a random access memory (RAM) and a read-only memory (ROM). The computer program may be recorded on a computer-readable storage medium, for example, and transferred to an electronic device via the computer-readable storage medium and executed therein.

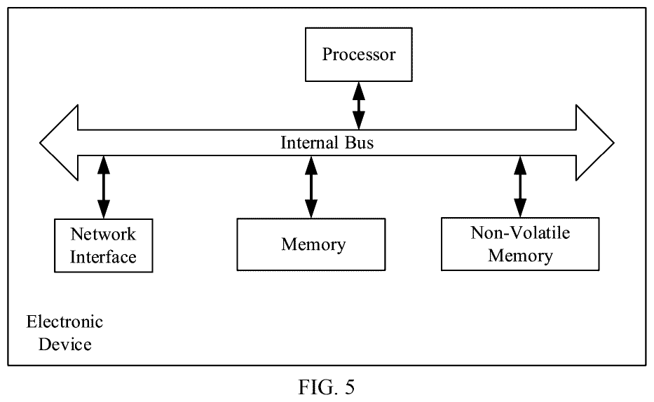

FIG. 5 is a schematic block diagram of an electronic device according to an embodiment of the present application. Referring to FIG. 5, at the hardware level, the electronic device includes a processor, and the electronic device may further includes an internal bus, a network interface, and a storage. The storage may include memory, such as high-speed random access memory (RAM), and may further include a non-volatile memory, such as at least one disk storage device. The electronic device may further include hardware required for other services.

The processor, the network interface, and the storage may be interconnected through an internal bus, such as an Industry Standard Architecture (ISA) bus, a Peripheral Component Interconnect (PCI) bus, or an Extended Industry Standard Architecture (EISA) bus. These buses may include address buses, data buses, control buses, and the like. For ease of illustration, FIG. 5 shows only one bidirectional arrow, but this does not imply that there is only one bus or only one type of bus.

The storage is configured to store programs. For example, the program may include program code including computer operating instructions. The storage may include memory and non-volatile memory, and provides instructions and data to the processor.

The processor reads the corresponding computer program from the non-volatile memory into the memory and then runs the computer program, to form the text processing apparatus at the logical level. The processor executes the program stored in the storage and is configured to perform the following operations:
performing part-of-speech tagging on a sentence in a reference text for a first text to obtain respective categories of one or more words in the sentence, wherein the first text is generated based on a requirement text;
generating at least one second text for describing the sentence based on the words and the respective categories of the words; and
determining a quality score of the first text based on a degree of matching between the second text and the first text.

An embodiment of the present application shown in FIG. 2 may be applied to or implemented by the processor. The processor may be an integrated circuit chip with signal processing capability. During implementation, each step of the method may be performed by integrated logic circuits in hardware form or by software instructions in the processor. The processor may be a general-purpose processor, including a central processing unit (CPU), a network processor (NP), etc.; the process may further include a digital signal processor (DSP), an application-specific integrated circuit (ASIC), a field-programmable gate array (FPGA), or other programmable logic devices, discrete gate or transistor logic devices, or discrete hardware components. The methods, steps, and logic block diagrams disclosed in the embodiments of the present application may be implemented or executed. The general-purpose processor may be a microprocessor or any conventional processor. The steps of the method disclosed in the embodiments of the present application may be directly implemented and executed by a hardware decoding processor, or by a combination of hardware and software modules in the decoding processor. The software module may be located in a storage medium well-known in the art, such as random access memory, flash memory, read-only memory, programmable read-only memory, electrically erasable programmable memory, registers, etc. The storage medium is located in the memory, and the processor reads the information in the memory and completes the steps of the above text processing method in conjunction with its hardware.

The electronic device may execute the text processing method in FIG. 2 and realize the functions of the text processing device in the embodiments shown in FIGS. 2 and 3. The embodiments of the present application will not be described in detail here.

In addition to software implementation, the electronic device according to an embodiment of the present application does not exclude other implementations, such as logic devices or a combination of software and hardware, etc. That is, the execution subject of the following processing flow is not limited to respective logic units, but may also be hardware or logic devices.

An embodiment of the present application further provides a computer-readable storage medium that stores one or more programs. The one or more programs include instructions. When executed by the electronic device including application programs, the instructions enable the electronic device to perform the method according to the embodiment shown in FIG. 2, and are configured to perform the following operations:
performing part-of-speech tagging on a sentence in a reference text for a first text to obtain respective categories of one or more words in the sentence, wherein the first text is generated based on a requirement text;
generating at least one second text for describing the sentence based on the words and the respective categories of the words; and
determining a quality score of the first text based on a degree of matching between the second text and the first text.

An embodiment of the present application further provides a computer program product. The computer program product includes a non-transitory computer-readable storage medium storing a computer program, and the computer program is operable to enable the computer to execute some or all of the steps in the text processing method according to the embodiment of the present application.

In sum, the above description is only some embodiment of the present application and is not intended to limit the scope of the present application. Any modifications, equivalent replacements, improvements, etc. made within the spirit and principles of the present application shall be included in the scope of the present application.

The systems, apparatus, modules, or units described in the above embodiments may be implemented by computer chips or entities, or by products having certain functions. An implementation device is a computer. For example, the computer may be a personal computer, a laptop computer, a cellular phone, a camera phone, a smartphone, a personal digital assistant, a media player, a navigation device, an email device, a game console, a tablet computer, a wearable device, or a combination of any of these devices.

Computer-readable media includes both permanent and non-permanent media, removable and non-removable media that may be implemented by using any method or technology for information storage. Information may be computer-readable instructions, data structures, program modules, or other data. Examples of storage media of the computer include, but are not limited to, phase-change RAM (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassettes, magnetic disk storage or other magnetic storage devices, or any other non-transmission media that may be used to store information that may be accessed by the computing device. As defined herein, the computer-readable media does not include transitory computer-readable media, such as modulated data signals and carrier waves.

It should also be noted that the terms “comprises,” “includes,” or any other variations thereof are intended to cover non-exclusive inclusion, such that a process, method, product, or device that includes a series of elements includes not only those elements but also other elements not explicitly listed, or includes elements inherent to such process, method, product, or device. In the absence of further limitations, an element defined by the phrase “includes a . . . ” does not exclude the presence of other identical elements in the process, method, product, or device that includes the element.

Some embodiments of the present application have been described in detail above. The description of the above embodiments merely aims to facilitate understanding of the present application. Many modifications or equivalent substitutions with respect to the embodiments may occur to those of ordinary skill in the art. Thus, these modifications or equivalent substitutions shall fall within the scope of the present application.

What is claimed is:

1. A text processing method, comprising:
performing part-of-speech tagging on a sentence in a reference text for a first text to obtain respective categories of one or more words in the sentence, wherein the first text is generated based on a requirement text;
generating at least one second text for describing the sentence based on the words and the respective categories of the words; and
determining a quality score of the first text based on a degree of matching between the second text and the first text.

2. The text processing method of claim 1, wherein the generating of the at least one second text based on the words and the respective categories of the words comprises:
generating a first question text based on a preset interrogative word and a first word of the words whose category is a verb;
obtaining a first answer text corresponding to the first question text from the sentence; and
generating the second text based on the first question text and the first answer text.

3. The text processing method of claim 2, wherein the obtaining of the first answer text from the sentence comprises:
determining a sentence component type corresponding to a preset interrogative word based on a type of the preset interrogative word; and
extracting a first sentence component belonging to the sentence component type from the sentence based on the respective categories of the words, as the first answer text.

4. The text processing method of claim 2, wherein the generating of the second text based on the first question text and the first answer text comprises:
combining the first question text with the first answer text to obtain a first question-answer pair;
reconstructing a first sentence based on the first question-answer pair; and
in response to verifying that the first sentence is semantically consistent with the sentence, determining the first question-answer pair as the second text.

5. The text processing method of claim 4, wherein the generating of the second text based on the first question text and the first answer text further comprises:
in response to verifying that the first sentence is semantically inconsistent with the sentence, obtaining information on semantic difference between the sentence and the first sentence; and
modifying the first question-answer pair based on the information on the semantic difference to obtain the second text.

6. The text processing method of claim 1, wherein the at least one second text comprises a plurality of second texts; and
the determining of the quality score of the first text comprises:
determining one or more of the second texts as one or more third texts, wherein a degree of matching between each of the one or more of the second texts and the first text reaches a preset matching degree threshold;
determining a first ratio of a number of the third texts to a number of the second texts; and
determining the quality score of the first text based on the first ratio.

7. The text processing method of claim 6, wherein the determining of the quality score of the first text based on the first ratio comprises:
determining a first coefficient based on a relationship between a length of the first text and a length of the reference text; and
determining the quality score of the first text based on the first coefficient and the first ratio.

8. The text processing method of claim 7, wherein the determining of the first coefficient comprises:
determining a second ratio of the length of the first text to the length of the reference text; and
performing a first exponential operation on the second ratio to obtain the first coefficient, wherein the first coefficient is negatively correlated with the second ratio.

9. The text processing method of claim 1, wherein the second text comprises a first question text and a first answer text corresponding to the first question text; and
the degree of matching between the second text and the first text is determined by:
extracting a second answer text corresponding to the first question text from the first text by using a first model; and
determining the degree of matching between the second text and the first text based on similarity between the second answer text and the first answer text.

10. An electronic device, comprising:
a processor; and
a storage storing instructions executable by the processor to perform operations comprising:
performing part-of-speech tagging on a sentence in a reference text for a first text to obtain respective categories of one or more words in the sentence, wherein the first text is generated based on a requirement text;
generating at least one second text for describing the sentence based on the words and the respective categories of the words; and
determining a quality score of the first text based on a degree of matching between the second text and the first text.

11. The electronic device of claim 10, wherein the generating of the second text based on the words and the respective categories of the words comprises:
generating a first question text based on a preset interrogative word and a first word of the words whose category is a verb;
obtaining a first answer text corresponding to the first question text from the sentence; and
generating the second text based on the first question text and the first answer text.

12. The electronic device of claim 11, wherein the obtaining of the first answer text from the sentence comprises:
determining a sentence component type corresponding to the preset interrogative word based on a type of the preset interrogative word; and
extracting a first sentence component belonging to the sentence component type from the sentence based on the respective categories of the words, as the first answer text.

13. The electronic device of claim 11, wherein the generating of the second text based on the first question text and the first answer text comprises:
combining the first question text with the first answer text to obtain a first question-answer pair;
reconstructing a first sentence based on the first question-answer pair; and
in response to verifying that the first sentence is semantically consistent with the sentence, determining the first question-answer pair as the second text.

14. The electronic device of claim 13, wherein the generating of the second text based on the first question text and the first answer text further comprises:
in response to verifying that the first sentence is semantically inconsistent with the sentence, obtaining information on semantic difference between the sentence and the first sentence, and modifying the first question-answer pair based on the information on the semantic difference to obtain the second text.

15. The electronic device of claim 10, wherein the at least one second text comprises a plurality of second texts; and
the determining of the quality score of the first text comprises:
determining one or more of the second texts as one or more third texts, wherein a degree of matching between each of the one or more of the second texts and the first text reaches a matching degree threshold;
determining a first ratio of a number of the third texts to a number of the second texts; and
determining the quality score of the first text based on the first ratio.

16. The electronic device of claim 15, wherein the determining of the quality score of the first text based on the first ratio comprises:
determining a first coefficient based on a relationship between a length of the first text and a length of the reference text; and
determining the quality score of the first text based on the first coefficient and the first ratio.

17. The electronic device of claim 16, wherein the determining of the first coefficient comprises:
determining a second ratio of the length of the first text to the length of the reference text; and
performing a first exponential operation on the second ratio to obtain the first coefficient, wherein the first coefficient is negatively correlated with the second ratio.

18. The electronic device of claim 10, wherein the second text comprises a first question text and a first answer text corresponding to the first question text; and
the degree of matching between the second text and the first text is determined by:
extracting a second answer text corresponding to the first question text from the first text by using a first model; and
determining the degree of matching between the second text and the first text based on similarity between the second answer text and the first answer text.

19. A non-transitory computer-readable storage medium storing instructions executable by a processor of an electronic device to perform operations comprising:
performing part-of-speech tagging on a sentence in a reference text for a first text to obtain respective categories of one or more words in the sentence, wherein the first text is generated based on a requirement text;
generating at least one second text for describing the sentence based on the words and the respective categories of the words; and
determining a quality score of the first text based on a degree of matching between the second text and the first text.

20. A computer program product, comprising a computer program executable by a computer to perform the text processing method of claim 1.
